(19) United States
(12) Patent Application Publication
(10) Pub. No.: US 2015/0363073 A1
(43) Pub. Date: Dec. 17, 2015

(54) APPLICATION ICON ARRANGEMENT METHOD AND TERMINAL

(71) Applicant: DONGGUAN GOLDEX COMMUNICATION TECHNOLOGY CO., LTD., Dongguan (CN)

(72) Inventor: Yanmin JIN, Dongguan (CN)

(21) Appl. No.: 14/834,145

(22) Filed: Aug. 24, 2015

Related U.S. Application Data
(63) Continuation of application No. PCT/CN2014/070785, filed on Jan. 17, 2014.

(30) Foreign Application Priority Data
May 27, 2013 (CN) 201310201638.7

(51) Int. Cl. G06F 3/0481; G06F 3/0488; G06F 17/30

(52) U.S. Cl. CPC G06F 3/04817; G06F 17/30979; G06F 3/04886

(57) ABSTRACT

Embodiments of the present disclosure provide an application icon arrangement method and terminal. The method comprises: setting a touch-sensitive hotspot zone in a screen area of a display page on a terminal; setting a plurality of icon display units in the touch-sensitive hotspot zone, in which are used to place an application icon; setting a sequence of placing the application icon into each of the plurality of icon display units; and placing the application icon into an icon display unit, according to a set position of the icon display unit and the sequence. By implementing the embodiments of the present disclosure, the scope of a user operation on an application icon in the upper section of the screen can be narrowed, and the reliability of one-hand tapping operation on the application icon can be improved.

### CROSS-REFERENCE TO RELATED APPLICATIONS

This present application claims the benefit of priority to Chinese Patent Application NO. 201310201638.7 filed in Chinese Patent Office on May 27, 2013 and entitled “APPLICATION ICON ARRANGEMENT METHOD AND TERMINAL”, the content of which is hereby incorporated by reference in its entirety for all intended purposes.

### FIELD

The disclosure relates to a field of electronic technology, and particularly to, an application icon arrangement method and terminal.

### BACKGROUND

Nowadays, for a mobile electronic device such cell phone, tablet computer, etc., an application icon installed by a user can be arranged on a screen of the mobile electronic device, and the application icon may usually be placed starting from the upper and far left screen on the main menu page of the application, and may be placed in the left-to-right and top-to-bottom sequence. The user can launch a certain application on the main menu page by tapping the application icon.

Furthermore, to satisfy the user experience, the screen size of the mobile electronic device is increasing. However, the screen size may become too large for the user to operate the application icon on the upper screen, and in particular, it becomes unrealizable for the user to tap a certain application icon (for instance, the application icon located at the upper left screen) on the upper screen with one hand.

### SUMMARY

Embodiments of the present disclosure provide an application icon arrangement method and a terminal, in which the scope of a user operation on an application icon in the upper section of the screen can be narrowed, and the reliability of one-hand tapping operation on the application icon can be improved.

Specifically, embodiments of the present disclosure provide an application icon arrangement method, the method can include the following steps of:

setting a touch-sensitive hotspot zone in a screen area of a display page on a terminal;

setting a plurality of icon display units in the touch-sensitive hotspot zone, in which are used to place an application icon;

setting a sequence of placing the application icon into each of the plurality of icon display units; and

placing the application icon into an icon display unit, according to a set position of the icon display unit and the sequence.

Correspondingly, embodiments of the present disclosure also provide a terminal, the terminal can include:

a first setting unit, configured to set a touch-sensitive hotspot zone in a screen area of a display page on a terminal;

a second setting unit, configured to set a plurality of icon display units in the touch-sensitive hotspot zone, in which are used to place an application icon;

a third setting unit, configured to set a sequence of placing the application icon into each of the plurality of icon display units; and

a loading unit, configured to place the application icon into an icon display unit, according to a set position of the icon display unit and the sequence.

In one embodiment of the present disclosure, a touch-sensitive hotspot zone can be set in the screen area of each display page, and the touch-sensitive hotspot zone can be located at the lower half screen area, meanwhile the position to place an application icon on the display page can be limited in the touch-sensitive hotspot zone. Thus, the scope of a user operation on an application icon in the upper section of the screen can be narrowed, and the reliability of one-hand tapping operation on the application icon can be improved.

### BRIEF DESCRIPTION OF THE DRAWINGS

In order to illustrate the embodiments or existing technical solutions more clearly, a brief description of drawings that assists the description of embodiments of the invention or existing art will be provided below. It would be apparent that the drawings in the following description are only for some of the embodiments of the present disclosure. A person having ordinary skills in the art will be able to obtain other drawings on the basis of these drawings without paying any creative work.

FIG. 1 is a flowchart of an application icon arrangement method according to an embodiment of the present disclosure.

FIG. 2 is a position diagram of a touch-sensitive hotspot zone in an entire screen area according to an embodiment of the present disclosure.

FIG. 3 is a position diagram of a touch-sensitive hotspot zone in an entire screen area according to another embodiment of the present disclosure.

FIG. 4 is an arrangement diagram of a plurality of icon display units in a touch-sensitive hotspot zone according to an embodiment of the present disclosure.

FIG. 5 is a sequence tracking diagram of placing an application icon into a plurality of icon display units in FIG. 4 according to an embodiment of the present disclosure.

FIG. 6 is a sequence tracking diagram of placing an application icon into a plurality of icon display units in FIG. 4 according to another embodiment of the present disclosure.

FIG. 7 is a sequence tracking diagram of placing an application icon into a plurality of icon display units in FIG. 4 according to yet another embodiment of the present disclosure.

FIG. 8 is detailed flowchart of step S113 shown in FIG. 1 according to an embodiment of the present disclosure.

FIG. 9 is a status diagram of the plurality of icon display units shown in FIG. 5 according to an embodiment of the present disclosure.

FIG. 10 is detailed flowchart of step S113 shown in FIG. 1 according to another embodiment of the present disclosure.

FIG. 11 is a structure diagram of a terminal according to an embodiment of the present disclosure.

FIG. 12 is a structure diagram of the third setting unit shown in FIG. 11 according to an embodiment of the present disclosure.

FIG. 13 is a structure diagram of the loading unit shown in FIG. 11 according to an embodiment of the present disclosure.

FIG. 14 is structure diagram of a terminal according to another embodiment of the present disclosure.

### DETAILED DESCRIPTION OF ILLUSTRATED EMBODIMENTS

Further description of present disclosure will be illustrated clearly and completely, which combined with embodiments in drawings and detailed embodiments. Obviously, the embodiments herein are not all embodiments but only part of embodiments of present disclosure. Based on the embodiments of present disclosure, under premise of without paying out creative work, other embodiments obtained by the person having ordinary skill in the art are considered to encompass within the scope of the present disclosure.

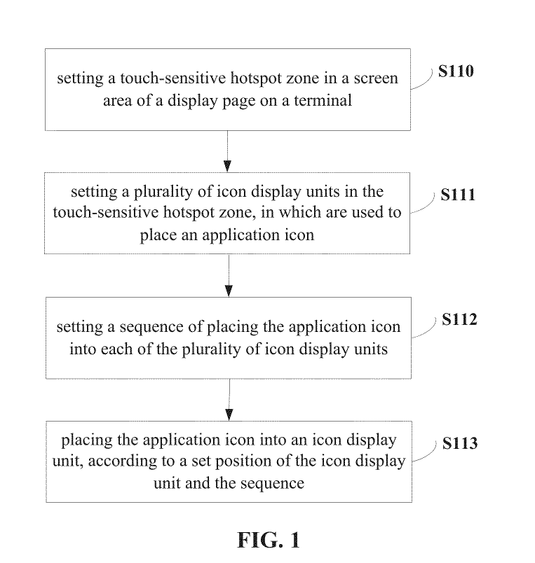

FIG. 1 is a flowchart of an application icon arrangement method according to an embodiment of the present disclosure. As shown in FIG. 1, the method can include the following steps.

Step S110, setting a touch-sensitive hotspot zone in a screen area of a display page on a terminal.

In a specific implementation, the terminal described in embodiments of the present disclosure can be a device such a cell phone, a handheld computer, a desktop computer, etc.

In a specific implementation, the display page described in embodiments of the present disclosure can be a main-menu application display interface supporting to display the monolayer of the main-menu application, or a desktop shortcut display interface of a terminal supporting to display the double layer of the desktop shortcut and the main-menu application, or the main-menu application display interface of the terminal supporting to display the double layer of the desktop shortcut and the main-menu application, or any other interface on which the application icon can be placed.

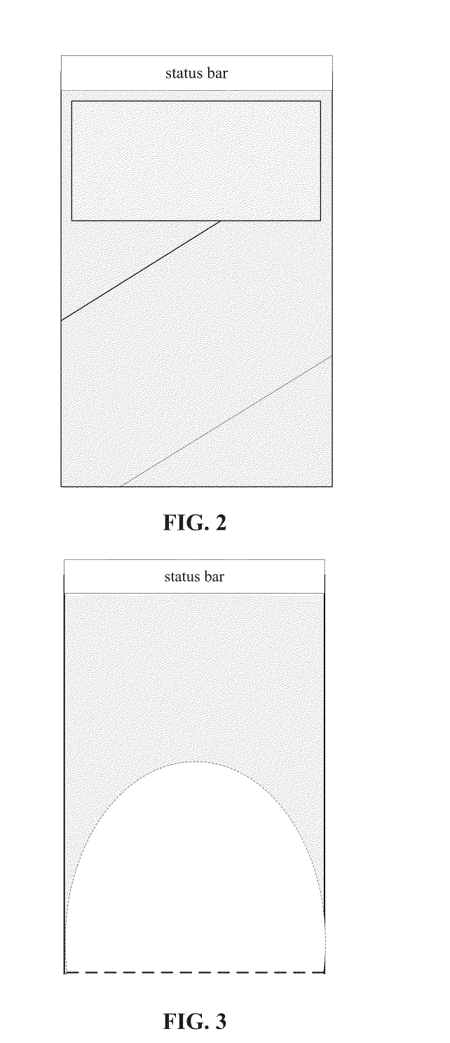

In a specific implementation, the touch-sensitive hotspot zone described in embodiments of the present disclosure can be located in the lower half of the screen area. For instance, the lower half of the screen area in which the touch-sensitive hotspot zone is located can be the entire lower half of the screen area; or the touch-sensitive hotspot zone can be a band-shaped zone from the lower left screen stretching to the upper right screen in the lower half of the screen area (such as the zone between the two oblique lines shown in FIG. 2); or the touch-sensitive hotspot zone can be an arc-shaped zone from the lower left screen stretching to the lower right screen in the lower half of the screen area (such as the zone in the dash line shown in FIG. 3). By setting the touch-sensitive hotspot zone, the position to place an application icon on the display page can be limited in the touch-sensitive hotspot zone. Thus, the scope of a user operation on an application icon in the upper section of the screen can be narrowed, and the reliability of one-hand tapping operation on the application icon can be improved, and the demand of one-hand tapping the application icon can be basically satisfied in the range of the touch-sensitive hotspot zone.

In a specific implementation, the touch-sensitive hotspot zone can be set by a parameter value of its endpoint coordinate, width, height, etc.

Step S111, setting a plurality of icon display units in the touch-sensitive hotspot zone, in which are used to place an application icon.

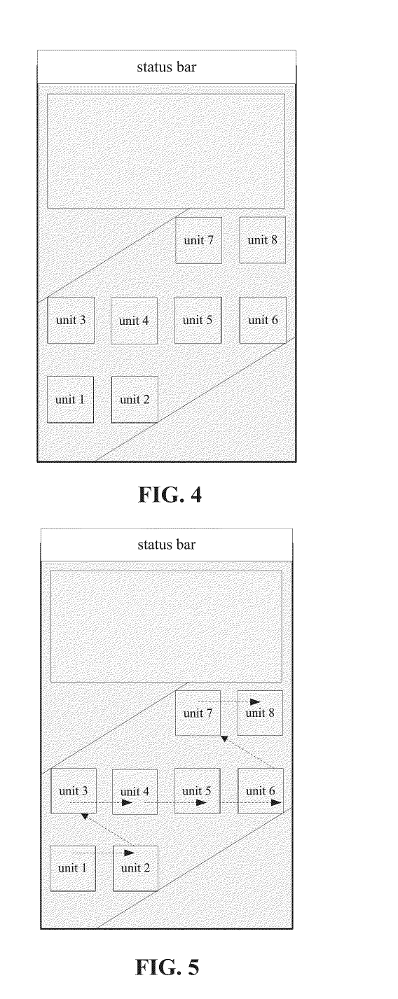

In a specific implementation, when a plurality of icon display units need to be set, the position and size of each of them can also be set by a parameter value of its endpoint coordinate, width, height, etc. Each of the plurality of icon display units can be arranged in the rule of a 3-row-4-column matrix. For example, for the touch-sensitive hotspot zone shown in FIG. 2, it can have at most eight application icons of application programs, and thus the arrangement shown in FIG. 4 can be formed.

Step S112, setting a sequence of placing the application icon into each of the plurality of icon display units.

In a specific implementation, the bottom and far left icon display unit in the range of the touch-sensitive hotspot zone can be set as a start, and the application icon can be placed sequentially into each of the plurality of icon display units in a left-to-right and bottom-to-top sequence. If the sequence of placing the application icon into each of the plurality of icon display units is applied in FIG. 4, the sequence tracking diagram shown in FIG. 5 can be formed, and the sequence can be taken as the track of the arrow shown in FIG. 5.

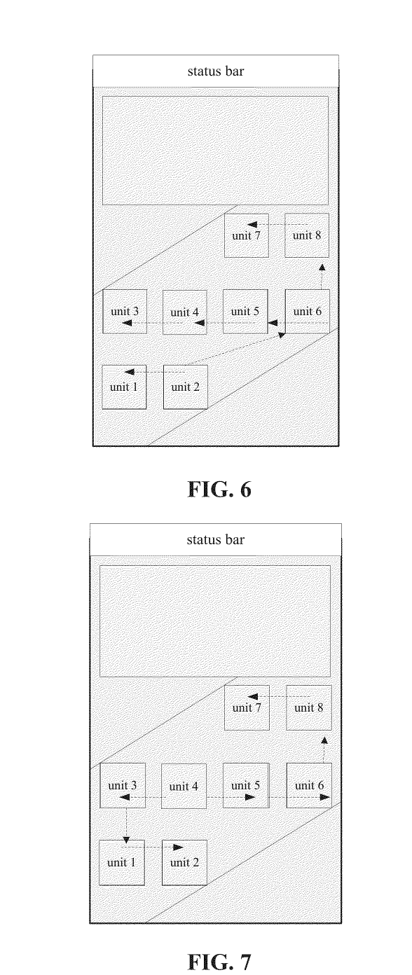

Or, the bottom and far right icon display unit in the range of the touch-sensitive hotspot zone can be set as a start, and the application icon can be placed sequentially into each of the plurality of icon display units in a right-to-left and bottom-to-top sequence. If the sequence of placing the application icon into each of the plurality of icon display units is applied in FIG. 4, the sequence tracking diagram shown in FIG. 6 can be formed, and the sequence can be taken as the track of the arrow shown in FIG. 6.

Or, the icon display unit which locates at the center area of the touch-sensitive hotspot zone can be set as a start, and the application icon can be placed sequentially into each of the plurality of icon display units in a center-to-edge sequence. If the sequence of placing the application icon into each of the plurality of icon display units is applied in FIG. 4, the sequence tracking diagram shown in FIG. 7 can be formed, and the sequence can be taken as the track of the arrow as shown in FIG. 7. The priority of the placement sequence of the icon display units besides the starting icon display unit can be set arbitrarily, and also can be set as the same.

In a special implementation, it would be sure that the sequence of placing the application icon into each of the plurality of icon display units can be set in other ways, which would not be described herein.

Step S113, placing the application icon into an icon display unit, according to a set position of the icon display unit and the sequence.

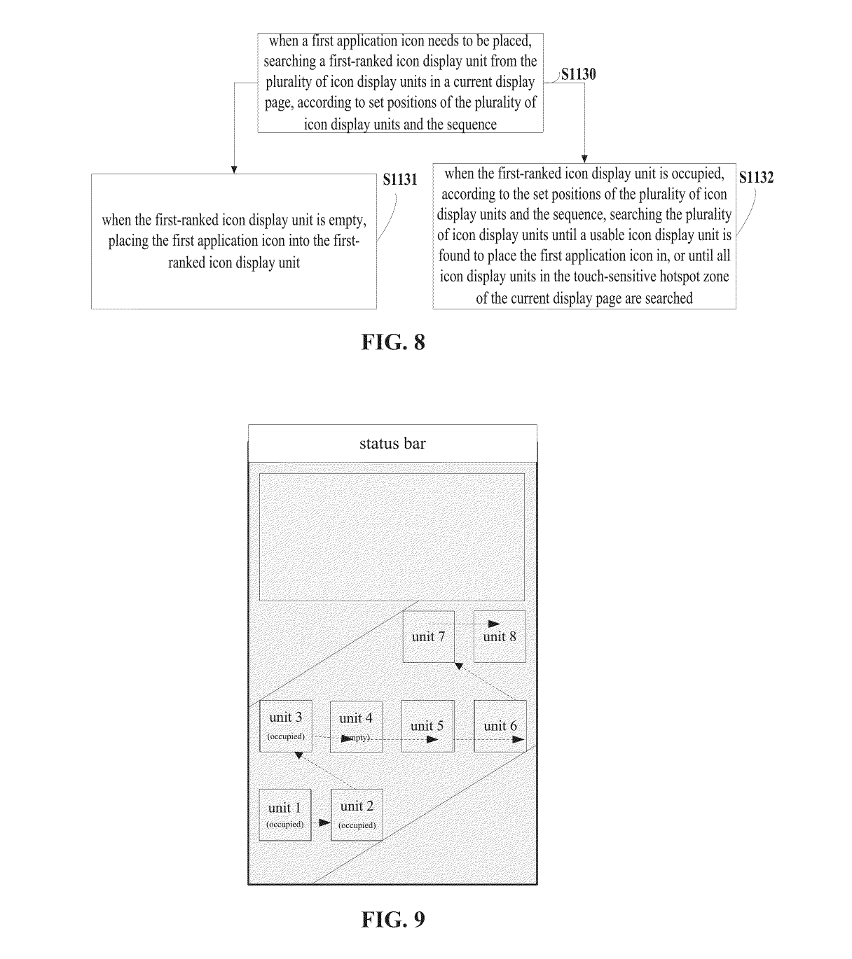

In a specific implementation, in step S113, the application icon can be placed into the icon display unit by implementing the following flow as shown in FIG. 8.

Step S1130, when a first application icon (e.g. a certain desktop application icon) needs to be placed, searching a first-ranked icon display unit from the plurality of icon display units in a current display page, according to set positions of the plurality of icon display units and the sequence.

Step S1131, when the first-ranked icon display unit is empty, placing the first application icon into the first-ranked icon display unit.

Step S1132, when the first-ranked icon display unit is occupied, according to the set positions of the plurality of icon display units and the sequence, searching the plurality of icon display units until a usable icon display unit is found to place the first application icon in, or until all icon display units in the touch-sensitive hotspot zone of the current display page are searched.

For conveniently illustration, FIG. 9 can be referred to herein for description. In FIG. 9, when the application icon of the certain desktop application needs to be placed, the first-ranked icon display unit named as unit 1 should be found at first, while as shown in FIG. 9, the unit 1 may be occupied, at this time, the icon display unit can be searched in the sequence of unit 2, unit 3, unit 4 until unit 8. As depicted in FIG. 9, unit 2 may also be found occupied, unit 3 would be continuously searched, which may yet be found occupied, and unit 4 would be continuously searched, which may be found empty, and thus, the application icon of the certain desktop application can be placed into unit 4.

In a specific implementation, all the icon display units may be found occupied when they are searched, at this time, if all the icon display units in the touch-sensitive hotspot zone of the current display page have been searched, the searching operation on the icon display units can be stopped.

In one embodiment, after setting the sequence of placing the application icon into each of the plurality of icon display units, the method can also include the step of:

setting a jumping sequence of a plurality of display pages.

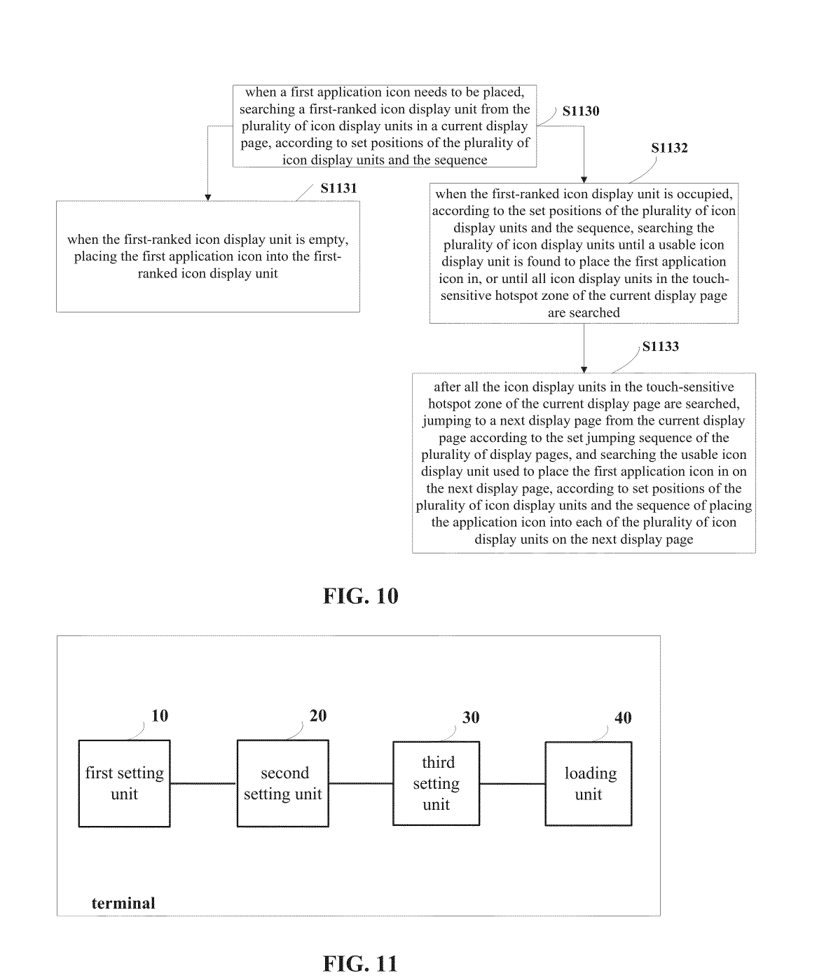

As shown in FIG. 10, step S113 can include:

step S1130, when a first application icon (e.g. a certain desktop application icon) needs to be placed, searching a first-ranked icon display unit from the plurality of icon display units in a current display page, according to set positions of the plurality of icon display units and the sequence;

step S1131, when the first-ranked icon display unit is empty, placing the first application icon into the first-ranked icon display unit;

step S1132, when the first-ranked icon display unit is occupied, according to the set positions of the plurality of icon display units and the sequence, searching the plurality of icon display units until a usable icon display unit is found to place the first application icon in, or until all icon display units in the touch-sensitive hotspot zone of the current display page are searched;

step S1133, after all the icon display units in the touch-sensitive hotspot zone of the current display page are searched, jumping to a next display page from the current display page according to the set jumping sequence of the plurality of display pages, and searching the usable icon display unit used to place the first application icon in on the next display page, according to set positions of the plurality of icon display units and the sequence of placing the application icon into each of the plurality of icon display units on the next display page. In the way above, the continuity for each display page can be built.

FIG. 11 is a structure diagram of a terminal according to an embodiment of the present disclosure. As shown in FIG. 11, the terminal can include: a first setting unit 10, a second setting unit 20, a third setting unit 30, and a loading unit 40.

Wherein, the first setting unit 10 can be configured to set a touch-sensitive hotspot zone in a screen area of a display page on a terminal.

In a specific implementation, the terminal described in embodiments of the present disclosure can be a device such a cell phone, a handheld computer, a desktop computer, etc.

In a specific implementation, the display page described in embodiments of the present disclosure can be a main-menu application display interface supporting to display the monolayer of the main-menu application, or a desktop shortcut display interface of a terminal supporting to display the double layer of the desktop shortcut and the main-menu application, or the main-menu application display interface of the terminal supporting to display the double layer of the desktop shortcut and the main-menu application, or any other interface on which the application icon can be placed.

In a specific implementation, the touch-sensitive hotspot zone described in embodiments of the present disclosure can be located in the lower half of the screen area. For instance, the lower half of the screen area in which the touch-sensitive hotspot zone is located can be the entire lower half of the screen area; or the touch-sensitive hotspot zone can be a band-shaped zone from the lower left screen stretching to the upper right screen in the lower half of the screen area (such as the zone between the two oblique lines shown in FIG. 2); or the touch-sensitive hotspot zone can be an arc-shaped zone from the lower left screen stretching to the lower right screen in the lower half of the screen area (such as the zone in the dash line shown in FIG. 3). By setting the touch-sensitive hotspot zone, the position to place an application icon on the display page can be limited in the touch-sensitive hotspot zone. Thus, the scope of a user operation on an application icon in the upper section of the screen can be narrowed, and the reliability of one-hand tapping operation on the application icon can be improved, and the demand of one-hand tapping the application icon can be basically satisfied in the range of the touch-sensitive hotspot zone.

In a specific implementation, the touch-sensitive hotspot zone can be set by a parameter value of its endpoint coordinate, width, height, etc.

The second setting unit 20 can be configured to set a plurality of icon display units in the touch-sensitive hotspot zone, in which are used to place an application icon.

In a specific implementation, when a plurality of icon display units need to be set, the position and size of each of them can also be set by a parameter value of its endpoint coordinate, width, height, etc. Each of the plurality of icon display units can be arranged in the rule of a 3-row-4-column matrix. For example, for the touch-sensitive hotspot zone shown in FIG. 2, it can have at most eight application icons of application programs, and thus the arrangement shown in FIG. 4 can be formed.

The third setting unit 30 can be configured to set a sequence of placing the application icon into each of the plurality of icon display units.

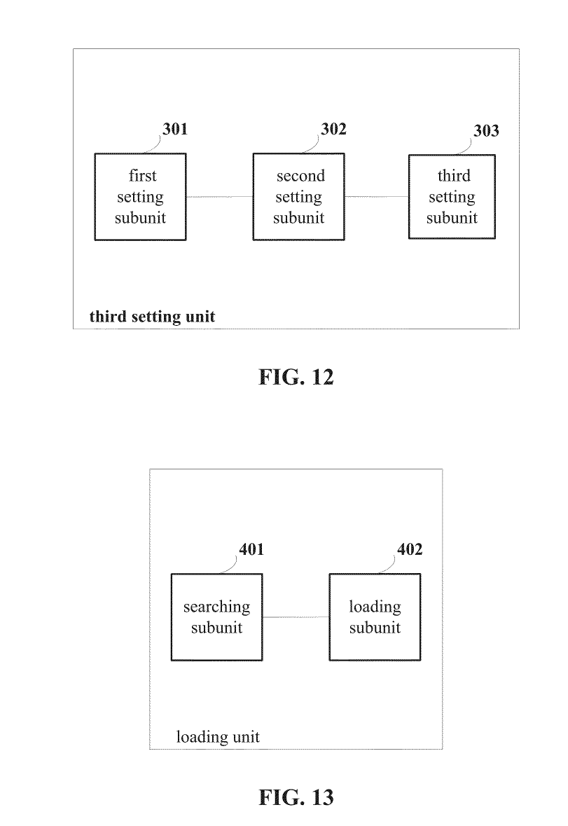

Referring to FIG. 12, in a specific implementation, the third setting unit 30 can include at least one of the subunits below.

A first setting subunit 301 can be configured to set the icon display unit which locates at the bottom and far left area of the touch-sensitive hotspot zone as a start, and place the application icon sequentially into each of the plurality of icon display units from left to right and from bottom to top. If the sequence of placing the application icon into each of the plurality of icon display units is applied in FIG. 4, the sequence tracking diagram shown in FIG. 5 can be formed, and the sequence can be taken as the track of the arrow shown in FIG. 5.

A second setting subunit 302 can be configured to set the icon display unit which locates at the bottom and far right area of the touch-sensitive hotspot zone as a start, and place the application icon sequentially into each of the plurality of icon display units from right to left and from bottom to top. If the sequence of placing the application icon into each of the plurality of icon display units is applied in FIG. 4, the sequence tracking diagram shown in FIG. 6 can be formed, and the sequence can be taken as the track of the arrow shown in FIG. 6.

A third setting subunit 303 can be configured to set the icon display unit which locates at the center area of the touch-sensitive hotspot zone as a start, and place the application icon sequentially into each of the plurality of icon display units from center to edge.

If the sequence of placing the application icon into each of the plurality of icon display units is applied in FIG. 4, the sequence tracking diagram shown in FIG. 7 can be formed, and the sequence can be taken as the track of the arrow as shown in FIG. 7. The priority of the placement sequence of the icon display units besides the starting icon display unit can be set arbitrarily, or also can be set as the same.

In a special implementation, it would be sure that the sequence of placing the application icon into each of the plurality of icon display units can be set in other ways, which would not be described herein.

The loading unit 40 can be configured to place the application icon into an icon display unit, according to a set position of the icon display unit and the sequence.

Referring to FIG. 13, in a specific implementation, the loading unit 40 can include:

a searching subunit 401, configured to, when a first application icon needs to be placed, search a first-ranked icon display unit from the plurality of icon display units in a current display page, according to set positions of the plurality of icon display units and the sequence;

a loading subunit, configured to, when the searching subunit 401 finds that the first-ranked icon display unit is empty, place the first application icon into the first-ranked icon display unit; and when the first-ranked icon display unit is occupied, according to the set positions of the plurality of icon display units and the sequence, indicate the searching subunit 401 to search the plurality of icon display units until a usable icon display unit is found to place the first application icon in, or until all icon display units in the touch-sensitive hotspot zone of the current display page are searched;

when the searching subunit 401 finds a usable icon display unit excluding the first-ranked icon display unit to place the first application icon in, the loading subunit 402 can be further configured to place the first application icon into the usable icon display unit.

In a specific implementation, after setting the sequence of placing the application icon into each of the plurality of icon display units, the third setting unit 30 can also be configured to set a jumping sequence of a plurality of display pages.

While the searching subunit 401 can also be configured to, after all the icon display units in the touch-sensitive hotspot zone of the current display page are searched, jump to a next display page from the current display page according to the set jumping sequence of the plurality of display pages, and to search the usable icon display unit used to place the first application icon in on the next display page, according to set positions of the plurality of icon display units and the sequence of placing the application icon into each of the plurality of icon display units on the next display page.

For conveniently illustration, FIG. 9 can be referred to herein for description. In FIG. 9, when the application icon of the certain desktop application needs to be placed, the first-ranked icon display unit named as unit 1 should be found at first, while as shown in FIG. 9, the unit 1 may be occupied, at this time, the icon display unit can be searched in the sequence of unit 2, unit 3, unit 4 until unit 8. As depicted in FIG. 9, unit 2 may also be found occupied, unit 3 would be continuously searched, which may yet be found occupied, and unit 4 would be continuously searched, which may be found empty, and thus, the application icon of the certain desktop application can be placed into unit 4.

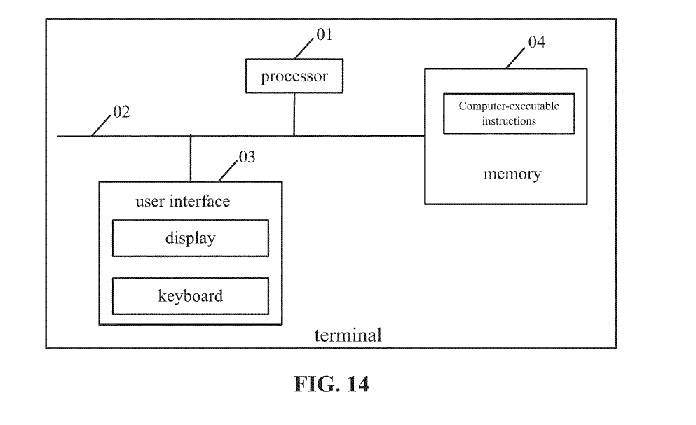

Referring to FIG. 14, it is a structure diagram of a terminal according to another embodiment of the present invention. As shown in FIG. 14, the terminal can include: at least one processor 01, such as a CPU; at least one user interface 03, a memory 04 and at least one communication bus 02 for implementing connections and communications among these devices. The user interface 03 can include a standard cable interface and a standard wireless interface; the memory 04 can include a high speed RAM storage; or may further include an non-volatile memory, such as at least one magnetic disk memory; or optionally, may further include at least one memory device far apart from the process 01. The memory 04 may have computer-executable instructions, and by executing the computer-executable instructions, the processor 01 can be configured to:

set a touch-sensitive hotspot zone in a screen area of a display page on a terminal;

set a plurality of icon display units in the touch-sensitive hotspot zone, in which are used to place an application icon;

set a sequence of placing the application icon into each of the plurality of icon display units; and

place the application icon into an icon display unit, according to a set position of the icon display unit and the sequence.

In an optional embodiment, the placing the application icon into an icon display unit, according to a set position of the icon display unit and the sequence comprises:

when a first application icon needs to be placed, searching a first-ranked icon display unit from the plurality of icon display units in a current display page, according to set positions of the plurality of icon display units and the sequence;

when the first-ranked icon display unit is empty, placing the first application icon into the first-ranked icon display unit; and

when the first-ranked icon display unit is occupied, according to the set positions of the plurality of icon display units and the sequence, searching the plurality of icon display units until a usable icon display unit is found to place the first application icon in, or until all icon display units in the touch-sensitive hotspot zone of the current display page are searched.

In an optional embodiment, wherein, the touch-sensitive hotspot zone is located in lower half of the screen area.

In an optional embodiment, wherein, the touch-sensitive hotspot zone is the entire lower half of the screen area; or

the touch-sensitive hotspot zone is a band-shaped zone from the lower left screen stretching to the upper right screen in the lower half of the screen area; or

the touch-sensitive hotspot zone is an arc-shaped zone from the lower left screen stretching to the lower right screen in the lower half of the screen area.

In an optional embodiment, wherein, after setting the sequence of placing the application icon into each of the plurality of icon display units, the processor is further configured to:

set a jumping sequence of a plurality of display pages on the terminal;

wherein, the processor is further configured to:

after all the icon display units in the touch-sensitive hotspot zone of the current display page are searched, jump to a next display page from the current display page according to the set jumping sequence of the plurality of display pages, and search the usable icon display unit used to place the first application icon in on the next display page, according to set positions of the plurality of icon display units and the sequence of placing the application icon into each of the plurality of icon display units on the next display page.

In an optional embodiment, wherein, the setting the sequence of placing the application icon into each of the plurality of icon display units comprises:

setting the icon display unit which locates at the bottom and far left area of the touch-sensitive hotspot zone as a start, and placing the application icon sequentially into each of the plurality of icon display units from left to right and from bottom to top; or

setting the icon display unit which locates at the bottom and far right area of the touch-sensitive hotspot zone as a start, and placing the application icon sequentially into each of the plurality of icon display units from right to left and from bottom to top; or

setting the icon display unit which locates at the center area of the touch-sensitive hotspot zone as a start, and placing the application icon sequentially into each of the plurality of icon display units from center to edge.

The execution sequence of steps in the method may be modified according to practical requirement. The units of the terminal in embodiments of the present disclosure can be combined or divided according to practical requirement. The terminal in embodiments of the present disclosure can be a cell phone, a computer, a mobile device, etc.

The units or subunits of the terminal in embodiments of the present disclosure can be realized by a common integrated circuit (such as a Central Processing Unit (CPU)), or an Application Specific Integrated Circuit (ASIC).

A person having ordinary skills in the art can realize that part or whole of the processes in the methods according to the above embodiments may be implemented by a computer program instructing relevant hardware. The program may be stored in a computer readable storage medium. When executed, the program may execute processes in the above-mentioned embodiments of methods. The storage medium may be a magnetic disk, an optical disk, a Read-Only Memory (ROM), a Random Access Memory (RAM), et al.

The above descriptions are some exemplary embodiments of the present disclosure, and should not be regarded as limitation to the scope of related claims. A person having ordinary skills in a relevant technical field will be able to make improvements and modifications within the spirit of the principle of the present disclosure. The improvements and modifications should also be incorporated in the scope of the claims attached below.

What is claimed is:

1. An application icon arrangement method, comprising:
setting a touch-sensitive hotspot zone in a screen area of a display page on a terminal;
setting a plurality of icon display units in the touch-sensitive hotspot zone, in which are used to place an application icon;
setting a sequence of placing the application icon into each of the plurality of icon display units; and
placing the application icon into an icon display unit, according to a set position of the icon display unit and the sequence.

2. The method according to claim 1, wherein the placing the application icon into an icon display unit, according to a set position of the icon display unit and the sequence, comprises:
when a first application icon needs to be placed, searching a first-ranked icon display unit from the plurality of icon display units in a current display page, according to set positions of the plurality of icon display units and the sequence;
when the first-ranked icon display unit is empty, placing the first application icon into the first-ranked icon display unit; and
when the first-ranked icon display unit is occupied, according to the set positions of the plurality of icon display units and the sequence, searching the plurality of icon display units until a usable icon display unit is found to place the first application icon in, or until all icon display units in the touch-sensitive hotspot zone of the current display page are searched.

3. The method according to claim 1, wherein, the touch-sensitive hotspot zone is located in lower half of the screen area.

4. The method according to claim 3, wherein, the touch-sensitive hotspot zone is the entire lower half of the screen area; or
the touch-sensitive hotspot zone is a band-shaped zone from the lower left screen stretching to the upper right screen in the lower half of the screen area; or
the touch-sensitive hotspot zone is an arc-shaped zone from the lower left screen stretching to the lower right screen in the lower half of the screen area.

5. The method according to claim 2, wherein after setting the sequence of placing the application icon into each of the plurality of icon display units, the method further comprises:
setting a jumping sequence of a plurality of display pages on the terminal;
wherein, the method further comprises:
after all the icon display units in the touch-sensitive hotspot zone of the current display page are searched, jumping to a next display page from the current display page according to the set jumping sequence of the plurality of display pages, and searching the usable icon display unit used to place the first application icon in on the next display page, according to set positions of the plurality of icon display units and the sequence of placing the application icon into each of the plurality of icon display units on the next display page.

6. The method according to claim 1, wherein the setting the sequence of placing the application icon into each of the plurality of icon display units, comprises:
setting the icon display unit which locates at the bottom and far left area of the touch-sensitive hotspot zone as a start, and placing the application icon sequentially into each of the plurality of icon display units from left to right and from bottom to top; or
setting the icon display unit which locates at the bottom and far right area of the touch-sensitive hotspot zone as a start, and placing the application icon sequentially into each of the plurality of icon display units from right to left and from bottom to top; or
setting the icon display unit which locates at the center area of the touch-sensitive hotspot zone as a start, and placing the application icon sequentially into each of the plurality of icon display units from center to edge.

7. A terminal, comprising:
a first setting unit, configured to set a touch-sensitive hotspot zone in a screen area of a display page on a terminal;
a second setting unit, configured to set a plurality of icon display units in the touch-sensitive hotspot zone, in which are used to place an application icon;
a third setting unit, configured to set a sequence of placing the application icon into each of the plurality of icon display units; and
a loading unit, configured to place the application icon into an icon display unit, according to a set position of the icon display unit and the sequence.

8. The terminal according to claim 7, wherein the loading unit comprises:
a searching subunit, configured to, when a first application icon needs to be placed, search a first-ranked icon display unit from the plurality of icon display units in a current display page, according to set positions of the plurality of icon display units and the sequence; and
a loading subunit, configured to, when the first-ranked icon display unit is empty, place the first application icon into the first-ranked icon display unit; and when the first-ranked icon display unit is occupied, according to the set positions of the plurality of icon display units and the sequence, indicate the searching subunit to search the plurality of icon display units until a usable icon display unit is found to place the first application icon in, or until all icon display units in the touch-sensitive hotspot zone of the current display page are searched;
when the searching subunit finds a usable icon display unit excluding the first-ranked icon display unit to place the first application icon in, the loading subunit is further configured to place the first application icon into the usable icon display unit.

9. The terminal according to claim 7, wherein, the touch-sensitive hotspot zone is located in lower half of the screen area.

10. The terminal according to claim 9, wherein, the touch-sensitive hotspot zone is the entire lower half of the screen area; or
the touch-sensitive hotspot zone is a band-shaped zone from the lower left screen stretching to the upper right screen in the lower half of the screen area; or
the touch-sensitive hotspot zone is an arc-shaped zone from the lower left screen stretching to the lower right screen in the lower half of the screen area.

11. The terminal according to claim 8, wherein, after the third setting unit sets the sequence of placing the application icon into each of the plurality of icon display units, it is further configured to set a jumping sequence of a plurality of display pages on the terminal;
the searching subunit is further configured to, after all the icon display units in the touch-sensitive hotspot zone of the current display page are searched, jump to a next display page from the current display page according to the set jumping sequence of the plurality of display pages, and to search the usable icon display unit used to place the first application icon in on the next display page, according to set positions of the plurality of icon display units and the sequence of placing the application icon into each of the plurality of icon display units on the next display page.

12. The terminal according to claim 7, wherein, the third setting unit comprises at least one of the following subunits:
a first setting subunit, configured to set the icon display unit which locates at the bottom and far left area of the touch-sensitive hotspot zone as a start, and place the application icon sequentially into each of the plurality of icon display units from left to right and from bottom to top;
a second setting subunit, configured to set the icon display unit which locates at the bottom and far right area of the touch-sensitive hotspot zone as a start, and place the application icon sequentially into each of the plurality of icon display units from right to left and from bottom to top;
a third setting subunit, configured to set the icon display unit which locates at the center area of the touch-sensitive hotspot zone as a start, and place the application icon sequentially into each of the plurality of icon display units from center to edge.

13. A terminal, comprising a memory having computer-executable instructions, and a processor coupled to the memory and configured to execute the computer-executable instructions to:
set a touch-sensitive hotspot zone in a screen area of a display page on a terminal;
set a plurality of icon display units in the touch-sensitive hotspot zone, in which are used to place an application icon;
set a sequence of placing the application icon into each of the plurality of icon display units; and
place the application icon into an icon display unit, according to a set position of the icon display unit and the sequence.

14. The terminal according to claim 13, wherein the processor being configured to execute the computer-executable instructions to place the application icon into an icon display unit, according to a set position of the icon display unit and the sequence comprises:
when a first application icon needs to be placed, searching a first-ranked icon display unit from the plurality of icon display units in a current display page, according to set positions of the plurality of icon display units and the sequence;
when the first-ranked icon display unit is empty, placing the first application icon into the first-ranked icon display unit; and
when the first-ranked icon display unit is occupied, according to the set positions of the plurality of icon display units and the sequence, searching the plurality of icon display units until a usable icon display unit is found to place the first application icon in, or until all icon display units in the touch-sensitive hotspot zone of the current display page are searched.

15. The terminal according to claim 13, wherein, the touch-sensitive hotspot zone is located in lower half of the screen area.

16. The terminal according to claim 15, wherein, the touch-sensitive hotspot zone is the entire lower half of the screen area; or
the touch-sensitive hotspot zone is a band-shaped zone from the lower left screen stretching to the upper right screen in the lower half of the screen area; or
the touch-sensitive hotspot zone is an arc-shaped zone from the lower left screen stretching to the lower right screen in the lower half of the screen area.

17. The terminal according to claim 14, wherein, after setting the sequence of placing the application icon into each of the plurality of icon display units, the processor is further configured to:
set a jumping sequence of a plurality of display pages on the terminal;
wherein, the processor is further configured to:
after all the icon display units in the touch-sensitive hotspot zone of the current display page are searched, jump to a next display page from the current display page according to the set jumping sequence of the plurality of display pages, and search the usable icon display unit used to place the first application icon in on the next display page, according to set positions of the plurality of icon display units and the sequence of placing the application icon into each of the plurality of icon display units on the next display page.

18. The terminal according to claim 13, wherein the processor being configured to execute the computer-executable instructions to set the sequence of placing the application icon into each of the plurality of icon display units comprises:
setting the icon display unit which locates at the bottom and far left area of the touch-sensitive hotspot zone as a start, and placing the application icon sequentially into each of the plurality of icon display units from left to right and from bottom to top; or
setting the icon display unit which locates at the bottom and far right area of the touch-sensitive hotspot zone as a start, and placing the application icon sequentially into each of the plurality of icon display units from right to left and from bottom to top; or
setting the icon display unit which locates at the center area of the touch-sensitive hotspot zone as a start, and placing the application icon sequentially into each of the plurality of icon display units from center to edge.
